(19) United States
(12) Patent Application Publication
(10) Pub. No.: US 2024/0409405 A1
(43) Pub. Date: Dec. 12, 2024

(54) PRODUCTS COMPRISING DEUTERIUM-ENRICHED WATER

(71) Applicant: Lennham Pharmaceuticals, Inc., Concord, MA (US)

(72) Inventors: Bradford C. Sippy, Acton, MA (US); Benjamin D. Enerson, Sudbury, MA (US)

(73) Assignee: Lennham Pharmaceuticals, Inc., Concord, MA (US)

(21) Appl. No.: 18/273,963

(22) PCT Filed: Jan. 24, 2022
(86) PCT No.: PCT/US2022/013518

§ 371 Date: Jul. 24, 2023

Related U.S. Application Data
(60) Provisional application No. 63/141,343, filed on Jan. 25, 2021.

(51) Int. Cl. C01B 5/02; A23L 2/56; C12G 3/05

(52) U.S. Cl. CPC C01B 5/02; A23L 2/56; C12G 3/05

(57) ABSTRACT

Provided herein are products for consumers comprising a greater than naturally-occurring amount of deuterium oxide.

### RELATED APPLICATIONS

This application claims priority under 35 U.S.C. § 119 (e) to U.S. Provisional Application No. 63/141,343, filed Jan. 25, 2021, the contents of which are incorporated herein by reference in their entirety.

### BACKGROUND

Water is the world's most widely consumed beverage. While the vast number of water molecules in ordinary (naturally-occurring) water consist of two hydrogen (H) atoms and one oxygen (O) atom, a small percentage of water molecules contain one or more deuterium atoms in place of a hydrogen atom. Specifically, for ordinary water, it is estimated that 0.0139% and 0.0156% of the hydrogen atoms in fresh water and salt water, respectively, are deuterium. See Blake et al., Studies with Deuterated Drugs, Journal of Pharmaceutical Sciences, Vol. 64, No. 3, 1975 (367-391).

Deuterium oxide (D₂O), also known as “heavy water”, is available in highly pure form (i.e. 99.85% or greater purity) for research use and has been extensively studied in vivo and in vitro. Based on prior studies, it has been suggested that replacing 30% or more of a human's body water with deuterium oxide may have severe toxic effects and possibly result in death. Despite being toxic at very high levels, deuterium oxide has been described as a “remarkably nontoxic substance”. See Blake et al., Studies with Deuterated Drugs, Journal of Pharmaceutical Sciences, Vol. 64, No. 3, 1975 at 370.

Despite being extensively studied, products comprising deuterium oxide (or heavy water) have never been available to consumers. Instead, recent efforts have been made to remove deuterium from consumer products, for example, from water to produce more purified forms of water for human consumption. “Deuterium-depleted water” (also known as “DDW” or “light water”)) is currently available for sale, for example, as DIVINIA WATER (http://www.diviniawater.com) and HYDROHEALTH water (https://extralightwater.com). Several claims have been made about the health benefits of drinking deuterium-depleted water, including that consumption may have anti-aging effects.

Described herein are products, including beverages, food products, and cosmetic products, comprising water which contains greater than a naturally-occurring amount of deuterium oxide.

### SUMMARY OF THE INVENTION

The present invention relates to products comprising water that contains greater than the naturally-occurring amount of deuterium oxide as would be found in ordinary water. In some embodiments, the products are consumer products, i.e. for consumption by a consumer. In some embodiments, the consumer is a mammal. In some embodiments, the mammal is a human. In some embodiments, the mammal is a domestic or tamed animal, such as a dog or cat.

In some embodiments, a beverage is provided, the beverage comprising greater than a naturally-occurring amount of deuterium oxide. In some embodiments, the beverage comprises a water mixture comprising a mixture of water from a first and second source, wherein the water mixture comprises 30, 25, 20, 15, 10, 9, 8, 7, 6, 5, 4, 3, 2, or 1 mole percent (%) or less deuterium oxide, wherein the water from the first source contains a naturally-occurring amount of deuterium oxide, and wherein the water from the second source contains more than a naturally-occurring amount of deuterium oxide. In other embodiments, the beverage may further comprise caffeine and/or alcohol. In some embodiments, the caffeine is a deuterated caffeine as described in PCT/US2020/037485, the contents of which are incorporated herein by reference in their entirety. In other embodiments, the beverage further comprises natural or artificial flavors, sugar, sweeteners, vitamins, and minerals.

In some embodiments, a method is provided for manufacturing a beverage comprising a water mixture having 30, 25, 20, 15, 10, 9, 8, 7, 6, 5, 4, 3, 2, or 1 mole percent (%) or less deuterium oxide, the method comprising: obtaining water having a naturally-occurring amount of deuterium oxide from a first source; obtaining water having greater than a naturally-occurring amount of deuterium oxide from a second source; mixing the water from the first source and the second source to produce the water mixture.

In some embodiments, the beverage comprises water containing deuterium oxide in an amount that is safe for general human consumption. In some embodiments, the amount of deuterium oxide in the water that is safe for general human consumption is equal to or less than 30, 25, 20, 15, 10, 9, 8, 7, 6, 5, 4, 3, 2, or 1 mole percent (%) of the water. In some embodiments, the amount of deuterium oxide in the water that is safe for general human consumption is less than 10 mole percent (%) of the water.

In some embodiments, the amount of deuterium oxide in the beverage does not produce a clinically-relevant or statistically-significant (p<0.05) hypotensive (antihypertensive) effect in a human when consumed once daily, twice daily, three times daily, four times daily, five times daily, or at more frequent intervals. In some embodiments, the amount of deuterium oxide in the beverage does not produce a clinically-relevant or statistically-significant (p<0.05) hypotensive (antihypertensive) effect in a human when consumed once weekly, twice weekly, three times per week, four times per week, five times per week, six times per week, seven times per week, or at more frequent intervals.

In some embodiments, a method is described for providing the beverage described herein to a human consumer, wherein consumption of the beverage promotes longevity in the human as measured by one or more biomarkers.

In some embodiments, a food product is provided, wherein the food product comprises water, and wherein the water comprises greater than a naturally-occurring amount of deuterium oxide. In some embodiments, the amount of the deuterium oxide in the water of the food product is equal to or greater than 0.02, 0.05, 0.1, 0.25, 0.5, 1, 2, 3, 4, 5, 10, 15, 20, 25, 30, 35, 40, 45, 50, 55, 60, 65, 70, 75, 80, 85, 90, 95, 97, 98, 99, 99.5, 99.7, or 99.9 mole percent (%).

In some embodiments, a cosmetic product is provided, wherein the cosmetic comprises water, and wherein the water comprises greater than a naturally-occurring amount of deuterium oxide. In some embodiments, the amount of the deuterium oxide in the water of the cosmetic is equal to or greater than 0.02, 0.05, 0.1, 0.25, 0.5, 1, 2, 3, 4, 5, 10, 15, 20, 25, 30, 35, 40, 45, 50, 55, 60, 65, 70, 75, 80, 85, 90, 95, 97, 98, 99, 99.5, 99.7, or 99.9 mole percent (%).

The details of one or more embodiments of the present disclosure are set forth herein. Other features, objects, and advantages of the present disclosure will be apparent from the Detailed Description, Examples, and Claims.

### Definitions

Before further description of the present invention, and in order that the invention may be more readily understood, certain terms are first defined and collected here for convenience.

The term “beverage” refers to a consumable liquid, regardless of whether regulated or marketed as a conventional food product (beverage) or dietary supplement. The term “energy beverage” refers to a type of beverage containing sugar and stimulant compounds (e.g., caffeine), which provides mental and physical stimulation.

The term “vitamin water” refers to water with added natural or artificial flavors, sugar, sweeteners, vitamins, and minerals.

The term “water” refers to water (H₂O) and its naturally occurring isotopes, including deuterium (D₂O) and water-¹⁸O (also known as “heavy-oxygen water”).

### DETAILED DESCRIPTION OF CERTAIN EMBODIMENTS OF THE INVENTION

In one aspect, the invention provides a product comprising water containing deuterium oxide in an amount greater than that found in ordinary (naturally-occurring) water.

In another aspect, the invention provides a beverage comprising water containing deuterium oxide in an amount greater than that found in ordinary (naturally-occurring) water. In another aspect, the beverage is a consumer beverage.

In another aspect, the beverage comprises ordinary water that has been “spiked” or enriched with deuterium oxide from a separate source to produce a water mixture that contains deuterium oxide in an amount greater than that found in ordinary water.

In another aspect, the beverage comprises one or more of water, flavoring agent(s), sweetener(s), vitamins, minerals, co-factors, proteins, lipids, peptides, and amino acids.

In another aspect, the beverage is an energy beverage. In another aspect, the energy beverage further comprises one or more of water, taurine, citicoline, vitamin B6, vitamin B12, folic acid, niacinamide, glucuronolactone, N-acetyl-L-tyrosine, L-phenylalanine, and malic acid.

In another aspect, the beverage is a vitamin water. In another aspect, the vitamin water further comprises one or more of water, vitamin C, vitamin B5, vitamin B6, vitamin B12, magnesium, and pantothenic acid.

In another aspect, the beverage is a caffeinated beverage.

In another aspect, the beverage is an alcohol beverage.

In another aspect, the beverage comprises 4 ounces, 6 ounces, 8 ounces, 10 ounces, 12 ounces, 16 ounces, 18 ounces, 20 ounces, 22 ounces, 24 ounces, ½ liter, 1 liter, ½ gallon, 1 gallon, or 2 gallons of the water mixture.

In another aspect, the beverage comprises a water mixture comprising a mixture of water from a first and second source, wherein the water mixture comprises at or about 30, 25, 20, 15, 10, 9, 8, 7, 6, 5, 4, 3, 2, or 1 mole percent (%) or less deuterium oxide, wherein the water from the first source contains an unmodified or naturally-occurring amount of deuterium oxide, and wherein the water from the second source contains greater than a naturally-occurring amount of deuterium oxide. The first source may be any source of water that is or is not altered, modified, or enhanced to be safe for human consumption, including water from a natural spring, water from a local water supply, or purified or filtered water from a local water supply or natural source. The second source may be any source of water that contains greater than a naturally-occurring amount of deuterium oxide, such as a preparation of highly pure deuterium oxide (i.e. 99.85% or greater purity), such that when mixed with the first source, a water mixture is produced having deuterium oxide in an amount greater than that found in the first source.

In another aspect, a method is provided for manufacturing a beverage comprising a water mixture having at or about 30, 25, 20, 15, 10, 9, 8, 7, 6, 5, 4, 3, 2, or 1 mole percent (%) or less deuterium oxide, the method comprising: obtaining water having a naturally-occurring amount of deuterium oxide from a first source; obtaining water having greater than a naturally-occurring amount of deuterium oxide from a second source; mixing the water from the first source and the second source to produce the water mixture.

In another aspect, the beverage is not a prescription product, not intended for, and/or not approved for a specific pharmacological use.

In another aspect, the amount of deuterium oxide in the beverage does not produce a clinically-relevant or statistically-significant (p<0.05) hypotensive (antihypertensive) effect in a human when consumed once daily or at more frequent intervals when compared to water containing a naturally-occurring amount of deuterium oxide.

In another aspect, consumption of the beverage by a mammal on a daily basis or more frequent intervals achieves a statistically-significant difference (p<0.05) in the expression of one or more longevity biomarkers. In certain aspects, consumption of the beverage by a mammal once daily or at more frequent intervals achieves at least a 1%, 2%, 5%, 10%, 15%, 20%, 25%, 30%, 35%, 40%, 45%, or 50% or greater change in the expression of one or more longevity biomarkers. In certain aspects, the longevity biomarker is insulin-like growth factor 1 (IGF-1). In certain aspects, consumption of the beverage results in a reduction of IGF-1 in the mammal. In certain aspects, the mammal is a mouse. In certain aspects, the mammal is a human. In certain aspects, the human is an adult human 18 years of age or older.

In another aspect, consumption of the beverage by a human on a weekly basis, or once, twice, three, four, five, or six times a week, or once daily, or at more frequent interval (e.g., twice daily, three times daily, four times daily, or more) decreases the level of IGF-1 in the human compared to the level of IGF-1 in the human prior to first consumption of the beverage. In certain aspects, the level of IGF-1 is measured using a commercially-available IGF-1 ELISA kit based on a comparison of IGF-1 in blood samples of the human taken (a) prior to the first consumption of the beverage and (b) during the period of time when the human is continuing to consume the beverage.

In another aspect, a method is provided for increasing the longevity of a consumer, wherein the method comprises providing the beverage described herein to a consumer. In another aspect, the consumer is a mammal. In another aspect, the mammal is a human. In certain aspects, the method comprises administering, or instructing the consumer to consume, the beverage at least once weekly, at least once daily, or at a more frequent basis. In certain aspects, the administering may be by oral administration. In certain aspects, the step of instructing the consumer may be provided directly or indirectly, e.g., by packaging or website materials associated with the beverage. In certain aspects, the step of increasing the longevity of a consumer is measured by reference to the effect of consumption of the beverage on one or more longevity biomarkers in a relevant animal model.

In another aspect, a method is provided for increasing the longevity of a consumer, wherein the method comprises consumption of the beverage described herein by the consumer. In certain aspects, the consumption is at least once weekly, at least once daily, or at a more frequent basis.

In another aspect, a food product is provided, wherein the food product comprises water, and wherein the water comprises greater than a naturally-occurring amount of deuterium oxide. In another aspect, the amount of the deuterium oxide in the water of the food product is equal to or greater than 0.02, 0.05, 0.1, 0.25, 0.5, 1, 2, 3, 4, 5, 10, 15, 20, 25, 30, 35, 40, 45, 50, 55, 60, 65, 70, 75, 80, 85, 90, 95, 97, 98, 99, 99.5, 99.7, or 99.9 mole percent (%). In another aspect, the amount of the deuterium oxide in the water of the food product is between 0.02-1%, 1-5%, 5-10%, 10-15%, 15-20%, 20-25%, 25-30%, 30-35%, 35-40%, 40-45%, 45-50%, 50-55%, 55-60%, 60-65%, 65-70%, 70-75%, 75-80%, 80-85%, 85-90%, 90-95%, or 95-100%.

In another aspect, the food product is any item that is to be processed, partially processed, or unprocessed for consumption. In another aspect, the food product is a food additive. In another aspect, the food product is an energy bar. In another aspect, the energy bar further comprises one or more of sugar, cocoa butter, chocolate liquor, whole milk powder, soy lecithin, vanilla extract, caramel, peanuts, peanut butter, almonds, oats, molasses, cinnamon, salt, and soybean oil.

In another aspect, a cosmetic product is provided, wherein the cosmetic comprises water, and wherein the water comprises greater than a naturally-occurring amount of deuterium oxide. In another aspect, the amount of the deuterium oxide in the water of the cosmetic product is equal to or greater than 0.02, 0.05, 0.1, 0.25, 0.5, 1, 2, 3, 4, 5, 10, 15, 20, 25, 30, 35, 40, 45, 50, 55, 60, 65, 70, 75, 80, 85, 90, 95, 97, 98, 99, 99.5, 99.7, or 99.9 mole percent (%). In another aspect, the amount of the deuterium oxide in the water of the cosmetic product is between 0.02-1%, 1-5%, 5-10%, 10-15%, 15-20%, 20-25%, 25-30%, 30-35%, 35-40%, 40-45%, 45-50%, 50-55%, 55-60%, 60-65%, 65-70%, 70-75%, 75-80%, 80-85%, 85-90%, 90-95%, or 95-100%.

In another aspect, the cosmetic product may be in the form of a liquid, a liquid emulsion, a cream, a solid, a paste, a gel, a powder, a multilayer form, a mousse, or a spray.

In another aspect, the cosmetic product may be a skin cosmetic which can be used in various areas of the face, fingers and nails including the scalp, lips, eyebrows, and throughout the body. Skin cosmetics may include skin cleansing products such as cleansing gels, cleansing creams, cleansing foams, facial cleansing creams, eye makeup removers, facial cleansing foams, liquid soaps (body soaps), hand soaps, shaving cream, nail polish remover, and acne treatment cosmetic. Skin cosmetics may also include skin care products such as skin creams, scalp treatments, skin lotions, milk lotions, emulsions, facial packs, body powders, essences, shaving lotions, and massage lotions. Skin cosmetics may also include makeup such as foundation, liquid foundation, oil-based foundation, makeup base, powder, face powder, lip cream, lipstick, lip gloss, eye shadow. Skin cosmetics may also include makeup products such as eye cream, eyebrow pencil, and eyelash cosmetic product. Skin cosmetics may also include deodorants, antiperspirants, sunscreens, and suntanning agents (suntan tanning agents).

In another aspect, the cosmetic product may be a hair cosmetic. Hair cosmetics may include hair cleansing agents such as shampoos, shampoos containing rinses, and the like. Hair cosmetics may also include hair styling products such as hair waxes, curl retainers, setting agents, hair creams, hair sprays, hair liquids, and the like. Hair cosmetics may also include hair coloring products such as hair color spray, hair color rinse, hair color stick, and the like. Hair cosmetics may also include hair care products, such as hair tonic, hair treatment essence, hair pack, and the like. Hair cosmetics may also include hair rinsing and hair conditioning products, such as oil rinses, cream rinses, treatment rinses, hair conditioners, hair treatments, and the like.

### Example 1-Protocol for Assessing Longevity

A study comparing the effect of the beverage described herein on longevity biomarkers may be conducted as follows. Inbred C57BL/6J mice from Jackson Laboratories are divided into two groups (A and B). Both groups are given access to standard chow during the study. Group A, the control group, is offered only ordinary (naturally-occurring) water during the study. Group B is offered only deuterium-enriched water containing a specific mole percent of deuterium oxide (e.g., 30, 25, 20, 15, 10, 9, 8, 7, 6, 5, 4, 3, 2, or 1 mole percent or less deuterium oxide) as described herein during the study. Additional groups of mice (e.g., Group C, D, etc.) may be included in the study to study the effects of consumption of deuterium-enriched water with differing mole percentages of deuterium oxide. Blood is drawn from the each of the mice at five weeks, or alternatively, at different predetermined time(s). IGF-1 levels are determined using a commercially available mouse IGF-1 ELISA kit, such as the “IGF-1 Mouse ELISA Kit” sold by Invitrogen/Thermo Fisher as Catalog #EMIGF1.

1. A beverage comprising water, wherein 35 mole percent or less of the water is deuterium oxide, and wherein the water contains more than a naturally-occurring amount of deuterium oxide.

2. The beverage of claim 1, comprising a water mixture, comprising water from a first and second source, wherein the water from the first source contains a naturally-occurring amount of deuterium oxide, and wherein the water from the second source contains more than a naturally-occurring amount of deuterium oxide.

3. The beverage of claim 1, wherein the water mixture comprises 25% mole percent or less deuterium oxide.

4. The beverage of claim 1, wherein the water mixture comprises 20% mole percent or less deuterium oxide.

5. The beverage of claim 1, wherein the water mixture comprises 10% mole percent or less deuterium oxide.

6. The beverage of claim 1, wherein the water mixture comprises 5% mole percent or less deuterium oxide.

7. The beverage of claim 1, wherein the water mixture comprises 1% mole percent or less deuterium oxide.

8. The beverage of claim 1, wherein the beverage further comprises caffeine, or a deuterated derivative thereof.

9. The beverage of claim 1, wherein the beverage is an energy beverage.

10. The beverage of claim 1, wherein the beverage further comprises alcohol.

11. The beverage of claim 1, wherein the beverage further comprises natural or artificial flavors, sugar, sweeteners, vitamins, and minerals.

12. The beverage of claim 1, wherein the beverage does not produce a hypotensive effect when consumed by a human.

13. The beverage of claim 12, wherein the beverage does not produce a statistically-significant hypotensive effect when consumed by a human on a daily or more frequent basis.

14. The beverage of claim 1, wherein consumption of the beverage achieves at least a 1%, 2%, 5%, 10%, 15%, 20%, 25%, 30%, 35%, 40%, 45%, or 50% or greater change in the expression of one or more longevity biomarkers.

15. The beverage of claim 14, wherein the longevity biomarker is IGF-1.

16. A method of increasing longevity in a consumer, the method comprising providing the beverage of claim 1 to the consumer.

17. The method of claim 16, wherein the consumer is a human.

18. A food product comprising water, wherein the water comprises equal to or greater than 0.02, 0.05, 0.1, 0.25, 0.5, 1, 2, 3, 4, 5, 10, 15, 20, 25, 30, 35, 40, 45, 50, 55, 60, 65, 70, 75, 80, 85, 90, 95, 97, 98, 99, 99.5, 99.7, or 99.9 mole percent (%) deuterium oxide.

19. A cosmetic product comprising water, wherein the water comprises equal to or greater than 0.02, 0.05, 0.1, 0.25, 0.5, 1, 2, 3, 4, 5, 10, 15, 20, 25, 30, 35, 40, 45, 50, 55, 60, 65, 70, 75, 80, 85, 90, 95, 97, 98, 99, 99.5, 99.7, or 99.9 mole percent (%) deuterium oxide.
